(19) United States
(12) Patent Application Publication
(10) Pub. No.: US 2010/0057499 A1
(43) Pub. Date: Mar. 4, 2010

(54) SYSTEMS AND METHODS FOR PROVIDING DISTRIBUTIONS TO ASSOCIATION MEMBERS BASED ON AFFINITY PROGRAMMING

(75) Inventor: Michael J. Fennelly, Canton, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BM Holdings, LLC, Canton, GA (US)

(21) Appl. No.: 12/204,601

(22) Filed: Sep. 4, 2008

(51) Int. Cl. G06Q 40/00

(52) U.S. Cl. 705/4; 705/40; 705/35; 705/30

(57) ABSTRACT

A system and method for providing distributions to members of an association based on members' purchases under affinity programs. In response to affinity program purchases by its members, the association receives a membership marketing fee or license fee which the association uses to pay a distribution to the purchasing members, payable after a holding period. The affinity program purchases may be made directly by association members, or through an intermediary who pays the royalty fee to the association based, for example, on a commission received from the supplier by the intermediary. A variety of goods and services can be provided under the affinity programs. The association also provides educational programs to its members.

### TECHNICAL FIELD

This invention relates to a novel process for providing services and distributions to members of an association and to computer implementation thereof in a system embodying the invention.

### BACKGROUND

Businesses are challenged to contain their costs in order to prosper. For example, pricing exposure in the areas of health care, insurance, public relations, advertising, accounting, legal, and web-site design and copy editing services, is difficult to manage. Businesses have sometimes been able to join in cooperative ways to exercise increased bargaining power, such as through purchasing cooperatives, but these organizations have serious disadvantages. Because members' financial strength and purchasing needs are not the same, the members do not benefit in proportion to the leverage they contribute to the group. When they lump member funds together to develop buying power and lower overall prices for group purchases, or to self-fund a particular liability, they face a new risk that one or several of the members' capital funds will diminish. This can lead to reduced buying power, or to the other members experiencing an additional financial burden to pay group receivables, covering the contributions expected from those who fail to meet their commitments.

A new approach has been needed for cost management, acceptable to customers, suppliers, and governmental regulators. Such an approach should result in cost savings to members attributable to membership in the group without exposing individual members to liability when another member defaults on an obligation. Furthermore, the cost savings should be in large part proportional to a member's participation in purchasing through the group.

### SUMMARY

The present invention seeks to provide systems and methods according to which businesses may improve business conditions and more efficiently manage their costs. Generally, the present invention provides a system and method for providing distributions to members of an association based on members' purchases under sponsored programs, sometimes referred to herein as affinity programs. In response to affinity program purchases by its members from sponsored suppliers, the association receives a membership marketing fee (sometimes herein called a license fee or a royalty fee), which the association uses to pay a distribution to the purchasing members. The affinity program purchases may be made directly by association members and the fee paid to the association by the supplier. In the alternative, such purchases may be made through an intermediary who pays the royalty fee to the association based, for example, on a commission, consulting fee or other revenue received from the supplier by the intermediary.

The association may negotiate with the supplier or intermediary to determine the amount of the license fee, and the result may be any negotiated portion of the revenue generated by a supplier in connection with affinity program purchases by members, or any portion of revenues received by an intermediary.

The association may enter arrangements with vendors or suppliers representing fields of goods or services in which costs are liabilities to employers. The members of the association, who have the same pricing exposures that they had absent membership, add minimal additional financial risk to their business operations, but receive cost saving distributions that are member specific, unlike the aspects of a traditional purchasing cooperative. Suppliers may also prefer to deal with association members for purchasing of goods and services, rather than negotiating with a cooperative group. An individual purchaser is a known entity with regard to credit risk, but visibility into the financial status of cooperative members may be problematic. Furthermore, the association assists the supplier in reaching members with marketing.

According to one aspect, the present invention provides an association computer system programmed with executable instructions configured to receive via a computer network notification of transfer to an account of the association in an association bank a fee based on payment by a member of the association to be applied to an affinity program purchase from a supplier; provide an instruction to an association bank computer system to hold the fee for a holding period; calculate a distribution amount based at least in part on the fee; and output a notice of the distribution amount. In one embodiment, the association computer system may be programmed to instruct the association bank computer system to provide, after the holding period, the calculated amount as a distribution to the member. The length of the holding period may be based on factors depending on the nature of the affinity purchases made by members.

In embodiments of the invention, a membership association implements a system and method for improving business conditions for its members. For example, the association may organize roundtable discussions or training programs. The programs may relate to any goods or services. The association may provide industry specific training, and training in such areas as human resources, business succession, investment strategy, marketing, risk management, insurance, techniques for enhancing the health and safety of workplaces and employees, or techniques for realizing savings in payment for goods or services.

The association may be a for profit or a nonprofit, taxable limited liability company established under the laws of a state such as Georgia, a corporation, or other entity that issues memberships or shares to its members entitling the members to receive dividends or other distributions. The association may have additional classes of membership not entitled to receive such distributions. For example, such members may join the association only to receive educational services.

According to one embodiment of the invention, following establishment of the association, membership may be offered to a select and limited number of employers. The association may be a party to a membership enrollment agreement with its members, requiring a yearly dues assessment or capital contribution payable, for example, annually in advance.

For example, the dues assessment may be $1.00 per full time employee of the member. Members are issued shares or other evidence of ownership representing an ownership interest in the association and entitling the member to receive distributions. The association may enable the members to receive other services, including, without limitation, educational programs. In the alternative, employers may pay as dues or capital contribution a flat fee negotiated with the association, or a fee based on past distributions, if the employer was a member in a past year or years. Under any of these alternative dues scenarios, the association optionally may add an administrative fee to the calculated or negotiated member dues, and may adjust the dues from time to time.

The return on a member's dues investment is dependent upon numerous factors including the number of participating members, the amount of affinity program purchase payments paid by members to sponsored third party vendors and the cost of the association's operations. Whether distributions are to be made in any given year (or other distribution payment period) may be dependent upon any one or any combination of: (i) association operating costs; (ii) license fees paid to the association by providers of affinity programming, pursuant to license agreements with suppliers or intermediaries; (iii) interest earned on the license fees.

According to some embodiments of the invention, the association enters into affinity royalty agreements with one or more business entities (herein sometimes referred to as “intermediaries”) pursuant to licenses, which may be exclusive or nonexclusive. Pursuant to such a license agreement, the association may authorize an intermediary to assist the members in purchasing goods or services from sponsored suppliers. Such an intermediary may, for example, find sponsored vendors for cellular telephone service for association members, or place group health and other insurance plans for association members with insurance vendors sponsored by the association. The license agreement may require the intermediary to pay license or royalty fees to the association. In return the association may sponsor the affinity purchasing plans and provide to the intermediary a list of association members. The license agreements thus provide disposable, net income to the association.

In some embodiments of the invention, the affinity programs relate to the purchase of insurance, such as property, inland marine, liability/casualty, automobile, health, workers compensation, directors & officers liability, bonding, or other insurance. Furthermore, in some embodiments multiple insurance lines may make up a members' “package policy” including coverage lines to insure: property and inland marine; business income; general liability; automobile (comprehensive, collision and liability); workers compensation; and commercial umbrella coverage. An intermediary insurance agency may obtain the lines of the package through different carriers, in which case an average commission or consulting fee may be used as a basis for the royalty fee paid to the association.

Thus, the license fees payable to the association resulting from insurance programs may depend upon the amount of revenue (for example, commissions or consulting fees) earned by intermediaries from providers of affinity programming based on premiums paid by members for insurance under association sponsored insurance programs or plans. In the example being described, the intermediary acts as a broker or agent or consultant in enrolling association members with insurance carriers so as to provide group health insurance to member employees, or other insurance to members. Members wishing to enroll in such insurance programs may provide a broker/agent of record letter (BOR/AOR letter) which may make the intermediary the member's exclusive broker or agent and authorize the intermediary to negotiate on the member's behalf with insurance carriers. The insurance carrier upon accepting the member as a policyholder issues an insurance policy to the member. Typically, such an intermediary forwards the premium to the insurance carrier and is paid a commission or consulting fee by the carrier out of the premium payment for placing the insurance policies, for example, from 1% to 30% or more. In one embodiment, out of this revenue the intermediary pays the association an annual license fee, for example from about 0.25% up to about 15% of the premiums collected by the intermediary resulting from enrollment of association members in the association sponsored insurance programs or plans. In another example, the license/marketing fee may be thirty percent (30%) of all insurance program related revenues received by the intermediary for sponsored insurance programs. The association may invest fees received from the intermediaries and receive interest or other investment returns as income. The association may distribute up to a high proportion of its net income to eligible members, for example from 20-100%, and in one embodiment of the invention, the association distributes 30% of its gross revenues to eligible members.

In one embodiment of the invention, license fee income from intermediaries may be distributed after the holding period following an affinity purchase. As noted, the length of the holding period may be based on factors depending on the nature of the affinity purchases made by members. For example, in the case of insurance, the holding period may be at least the length of an initial policy term, such as six months or one year. The holding period may also be set to optimize income to be applied to association expenses. Members eligible to receive distributions, in one embodiment, are those who maintain association membership for the full calendar year or other established period for which distributions are payable. For members participating in association sponsored insurance programs, a member's participation in distributions according to this embodiment may be proportionate to the amount of insurance premiums certified by the intermediary as paid by that member for the same year. Deductions may or may not be made, for example, for association expenses. The same calculation may be applied to non-insurance affinity program purchases.

Intermediaries may be utilized for implementing affinity purchasing programs in areas other than insurance. In any of these areas, the intermediary may also conduct programs other than purchasing programs for association members, such as the educational programs described above. Or, such other programs can be provided by the association itself, or by service providers not involved in purchasing programs. Those skilled in the art familiar with particular industries have knowledge of educational programs appropriate for and useful to members from those industries.

In other embodiments of the invention, the association will sponsor affinity programming for purchasing goods or services other than insurance related products, such as supplies, raw materials, or services. For example, an association pursuant to the invention may agree to sponsor a public relations firm with which the association enters into a license agreement. Members may be able to obtain services from the sponsored firm on an hourly, retainer, or fixed project fee basis. The vendor firm pays the association a royalty or membership marketing fee which the association holds for a holding period, such as the term of the contract between the vendor firm and the member, and then distributes the fee in the manner described above. The royalty fee may be a percentage of the total project invoice, or paid to the association periodically (such as monthly) based upon the number of billable hours billed by the vendor and paid by the member. Similar sponsored services may be provided to members in the case of advertising, accounting, legal, web-site design, copy editing, and various other services. Such purchases by members are affinity program purchases. In some cases, an intermediary may or may not be involved in placing the sponsored services. The availability of types of services or the involvement of an intermediary may depend on professional regulations or laws applying to the providers. The fee due the association from an intermediary may be calculated in a manner agreed upon between the intermediary and the association, such as a percentage of total revenue received by the intermediary from the affinity program purchase, or a percentage of a commission received by the intermediary.

Distributions may be provided in a similar manner to members based on purchases associated with both insurance and non-insurance affinity programs, and an association's members may participate in both insurance and non-insurance programs at the same time or during the same calendar year or other distribution payment period established by the association. In the case of non-insurance affinity programs, the distributions will be based on purchase payments made by members either directly or through intermediaries for sponsored goods or services in light of member marketing fees received by the association, and distributions will be paid to members to provide cost savings to members in a manner similar to that described above.

In other embodiments of the invention, the distribution may depend both on the amount of purchases (for example, insurance premiums or other affinity purchase payments) paid by the member and also on the amount of interest earned by the association on the fees received by the association either directly from sponsored vendors or from intermediaries. For example, an individual member's distribution may be the sum of 100% (or other established percentage) of the fees received from intermediaries attributable to that member's purchases, plus a share of a portion of the interest earned by the association on all such fees regardless of attribution. For example, twenty percent (20%) of such interest may be divided equally between the members. In one embodiment, a class of members not entitled to participate in distributions of license fees may receive a share of the interest income. In another embodiment, only the member in a class entitled to participate in distributions of license fees receive a share of the interest income. The amount of a distribution from license fees received, directly from vendors or from intermediaries, attributable to that member's purchases, may be reduced by an amount related to the operating expenses of the association or other charges, and may be, for example, from 20-100% of such license fees. Other income from operations or from sale or exchange of certain assets may also by used to fund distributions to members.

Each of the association, the intermediary, and the members may have a computer system and be associated with one or more banks or other financial institutions which also have computer systems. All such computer systems may be linked by a computer network and enabled to exchange data and instructions for carrying out conventional electronic funds transfer between bank accounts of respective parties. Funds transfers required may also be by credit card when appropriate.

According to another of its aspects, the present invention provides an association computer system programmed with executable instructions configured to receive via a computer network from an intermediary bank computer system notification of transfer to an account of the association in an association bank a royalty fee based on payment by a member of the association to be applied to an affinity program purchase from a supplier; provide an instruction to an association bank computer system to hold the fee for a holding period; calculate a distribution amount based at least in part on the fee; and instruct the association bank computer system to provide, after the holding period, the calculated amount as a distribution to the member. The royalty fee may be based on a commission received from the supplier by an intermediary, the commission being associated with the payment. The association computer system may be further programmed with executable instructions configured to receive via the computer network, notification from an intermediary computer system of payment by a member of the association to be applied to an affinity program purchase from a supplier. The system may calculate the distribution based at least in part on the payment, and may subtract predetermined deductions when calculating the distribution. According to one aspect, the system may, in calculating the distribution, add an amount proportional to interest earned by the association on the royalty fees attributable to affinity program purchases made by multiple members or by all members.

According to another of its aspects, the invention provides a member computer system programmed with executable instructions configured to instruct a member bank to transfer a payment to an intermediary to be applied to a purchase pursuant to an affinity program of an association to which the member belongs; and receive notification from an association computer system of a distribution transferred from an association bank to the member bank following a holding period, the distribution being based on a fee transferred to the association bank by the intermediary, the fee being funded by an intermediary commission associated with the payment.

According to another of its aspects, the invention provides an intermediary computer system programmed with executable instructions configured to instruct an intermediary bank to transfer payment received from an association member to a supplier to be applied to a purchase pursuant to an affinity program of an association to which the member belongs; send notification to an association computer system of the purchase; instruct the intermediary bank to transfer to an association bank a fee based on a commission received by the intermediary associated with the payment to the supplier; and send information relating to the commission and the fee to the association computer system.

According to another of its aspects, the invention provides a method for processing payments based on an affinity program, comprising receiving notification of a payment by a member of an association to be applied to an affinity program purchase from a supplier; receiving a fee associated with the payment; holding the fee for a holding period; calculating an amount based at least in part on the fee; and distributing, after the holding period, the calculated amount as a distribution to the member.

Such a method may be a computer implemented method for processing payments based on an affinity program, comprising receiving at an association computer system, via a computer network, notification of a payment by a member of an association to be applied to an affinity program purchase from a supplier; receiving in an account of the association a fee associated with the payment; holding the fee for a holding period; calculating, using the association computer system, an amount based at least in part on the fee; and distributing, after the holding period, the calculated amount as a distribution to the member.

### DESCRIPTION OF THE DRAWINGS

FIG. 1 is an overview of interactions and relationships according to an embodiment of the invented system and method in which an intermediary is involved, depicting the flow of information, funds, and obligations according to the present invention.

FIG. 2 provides a block diagram of a system for providing distributions based on affinity program purchases in accordance with exemplary embodiments of the invention.

FIG. 3 is an overview of interactions and relationships according to an embodiment of the invented system and method without an intermediary, depicting the flow of information, funds, and obligations according to the present invention.

FIG. 4 is a flowchart showing steps of a method according to the invention, for the embodiment shown in FIG. 1.

FIG. 5 is a flowchart showing steps of a method according to the invention, for the embodiment shown in FIG. 3.

FIG. 6 is a schematic block diagram of the association server in accordance with exemplary embodiments.

FIGS. 7 and 8 show examples of computer devices that can be used to implement the present invention.

### DESCRIPTION OF THE FIGURES

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

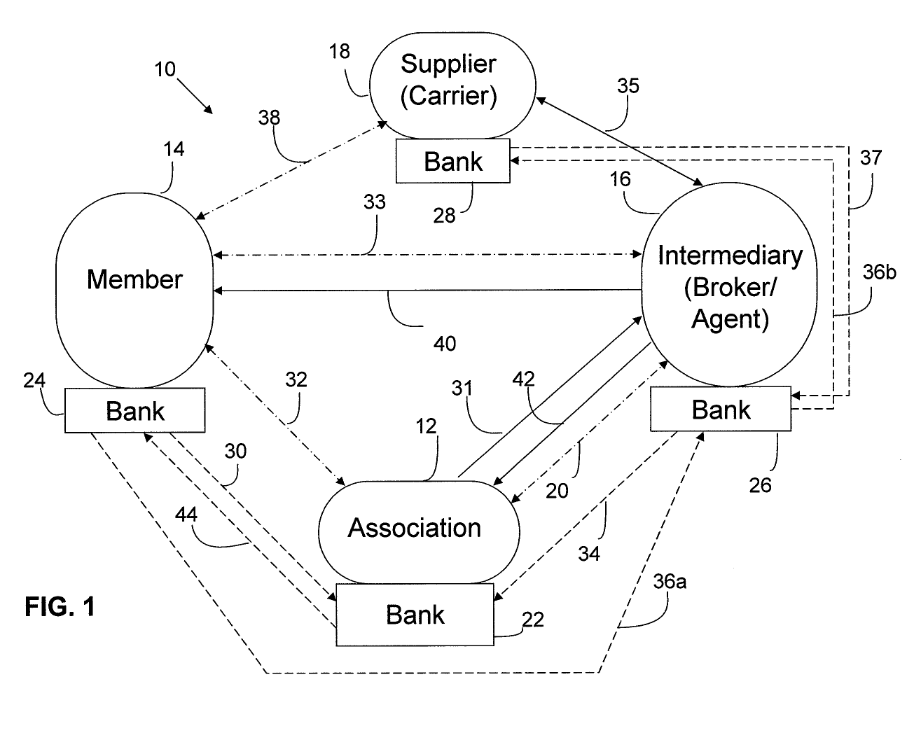

Referring now to FIG. 1, the relationships of the entities involved in an exemplary system 10 according to one embodiment of the present invention are shown diagrammatically, with the flow of information (solid arrows) and funds (dashed arrows) between them, and related agreements (dash-dot arrows) between them.

An association 12 may be a for profit or nonprofit, taxable limited liability company established under the laws of a state such as Georgia, a corporation, or other entity that issues memberships or shares to its members entitling at least one class of members to receive distributions. Additional classes of memberships may not be entitled to receive distributions. The association may provide a security under the form of a Uniform Limited Offering Exemption (“ULOE”) or “Regulation D” of Securities Act of 1933. In the alternative, the association may register its securities to be issued to members. The association may be a trade association.

As one example according to one embodiment, the association may establish Class A Members who must be employers of at least a threshold number of employees (for example, one hundred or more employees), who have limited voting rights, but who have the exclusive right to share in distributions. Such Class A Memberships in this example are annual memberships, i.e., must be renewed each calendar year by the payment of annual dues or capital contributions for each year of membership or otherwise terminate without a right to further distributions. The association in this example may further establish a single permanent Class B Member, the Managing Director, and Class C Members who are persons or entities who join the association by paying annual or other periodic dues in an amount determined by the Managing Director. Class C Members have no voting, distribution or liquidation rights, their interest in the Association being solely year to year and a non-equity interest. Class C Members are entitled to participate in wellness and other educational programs sponsored and held by the association but do not participate in affinity program purchases.

Following establishment of the association 12, membership may be offered to a select and limited number of employers for a yearly dues assessment or capital contribution 30 payable annually in advance. For example, the dues assessment may be $1.00 per full time employee of the member 14. In the alternative, employers may pay as dues or capital contribution a flat fee negotiated with the association, or a fee based on past distributions, if the employer was a member in a past year or years. Under any of these alternative dues scenarios, the association optionally may add an administrative fee to the calculated or negotiated member dues, and adjust the dues from time to time. Each new member 14 enters into a membership enrollment agreement 32 with the association 12, as described below. If the association is set up to issue memberships or securities that will not be registered under state law or with the United States Securities and Exchange Commission, the members may be required to execute an operating agreement limiting the sale, transfer, or pledge of the membership interests pursuant to state and federal law.

The association 12 enters into affinity royalty agreements with one or more business entities 16 (herein sometimes referred to as “intermediaries”) pursuant to license agreements 20, which may be exclusive or nonexclusive. The license agreements provide disposable, net income to the association 12 in the form of license or royalty fees 34, in exchange for the association authorizing an intermediary to, for example, place the association's sponsored goods or services with one or more suppliers 18. In the example shown in FIG. 1, the sponsored program is group health and other insurance plans for association members 14, but in other embodiments the sponsored programs may involve other goods or services. The association also furnishes and updates (as new members enroll in the association) a list 31 of association members to the intermediary 16. The association may send a separate notice of each new member, for example by email.

In the embodiment shown in FIG. 1, the intermediary 16 conducts programming including acting as a broker or agent in enrolling association members with insurance carriers (suppliers) 18 so as to provide group health insurance to member employees, workers compensation, directors & officers liability, or other insurance plans. The new member may provide a BOR/AOR letter 33 to the intermediary to authorize the intermediary to negotiate with insurance carriers 18. Communications by the intermediaries with carriers to enroll members are represented by double arrow 35 in FIG. 1. Typically, such an intermediary 16 earns revenue 37, such as a commission or consulting fee for placing the insurance policies 38 (contracts between the member and the carrier) based on the premium payment 36a received from the member 14, which is forwarded to the insurance carrier 18 as indicated at 36b. Insurance commissions, or in some cases, consulting fees, may fall within a range from about 1% to 30% or higher. In one embodiment, the intermediary pays the association an annual license fee 34, for example from about 0.25% up to about 15% of the premiums collected by the intermediary resulting from enrollment of association members 14 in the association sponsored insurance programs or plans. It can be seen that these license fee rates may be negotiated to bear a relationship to the commission or consulting fee earned by the intermediary, although they may be expressed as a percentage of the premiums paid. The association may invest receipts from the intermediaries and receive interest or other investment returns as income. The intermediary 16 may also conduct educational programming 40 for members as described above.

Upon enrollment of a member 14 in an insurance plan, the intermediary 14 sends notification 42 of this event to the association 12.

The association distributes up to a high proportion of its net income to eligible members as a distribution 44, after a holding period following an affinity purchase. The length of the holding period may be based on factors depending on the nature of the affinity purchases made by members. For example, in the case of insurance, the holding period may be at least the length of an initial policy term as stated in the policy, such as six months or one year. The holding period may also be set to optimize income to be applied to association expenses. Eligible members in one embodiment are those who maintain association membership for the full calendar year for which distributions are payable. For members participating in association sponsored insurance programs, a member's participation in distributions may be proportionate to the amount of insurance premiums certified by the intermediary as paid by that member for the same year. Deductions may be made for association expenses or on other bases established by the association. The return on a member's dues investment is dependent upon numerous factors including the number of participating members, the amount of premiums paid by members to third party vendors underwriting programs for individual association members and the cost of the association's operations.

Whether distributions are to be made in any given year may be dependent upon (i) association operating costs; and (ii) license fees paid to the association by providers of affinity programming, pursuant to the license agreements. For example, the license fees 34 payable to the association resulting from insurance programs may depend upon the revenue earned by intermediaries who place affinity programming based on purchase amounts or premiums paid by members for sponsored goods or services, such as insurance under association sponsored insurance programs or plans.

The association may also distribute income from operations other than funds from license fees or other payments resulting from affinity program purchases. For example, twenty percent (20%) of income from operations may be distributed to Class A Members in the example given above. Certain sales or exchanges such as of real property may be treated separately, and of these proceeds up to 100% distributed to Class A Members.

Each of the association, the intermediary, and the members may have a computer system as shown in subsequent Figures and each may be associated with one or more banks, shown in FIG. 1, or other financial institutions which also have computer systems. All such computer systems may be linked by a computer network and enabled to exchange data and instructions, or for providing instructions for or carrying out conventional electronic funds transfer between bank accounts of respective parties. Thus, the information flow shown in FIG. 1 may be between computer systems over a network, and the flow of funds shown in FIG. 1 may be by electronic funds transfers between the respective banks. That is, dues payment 30 may be an electronic funds transfer from member bank 24 to association bank 22, fee payment 34 may be an electronic funds transfer from intermediary bank 26 to association bank 22, premium payment 36 a (assuming insurance as an example of an affinity program) may be an electronic funds transfer from member bank 24 to intermediary bank 26, premium payment 36 b may be an electronic funds transfer from intermediary bank 26 to supplier bank 28, intermediary revenue payment 37 may be an electronic funds transfer from supplier bank 28 to intermediary bank 26, and distribution payment 44 may be an electronic funds transfer from association bank 22 to member bank 24. In each case the funds are transferred into an account of the respective receiving party. In the alternative, some or all of these funds transfers may be by on-line credit card payment over the network.

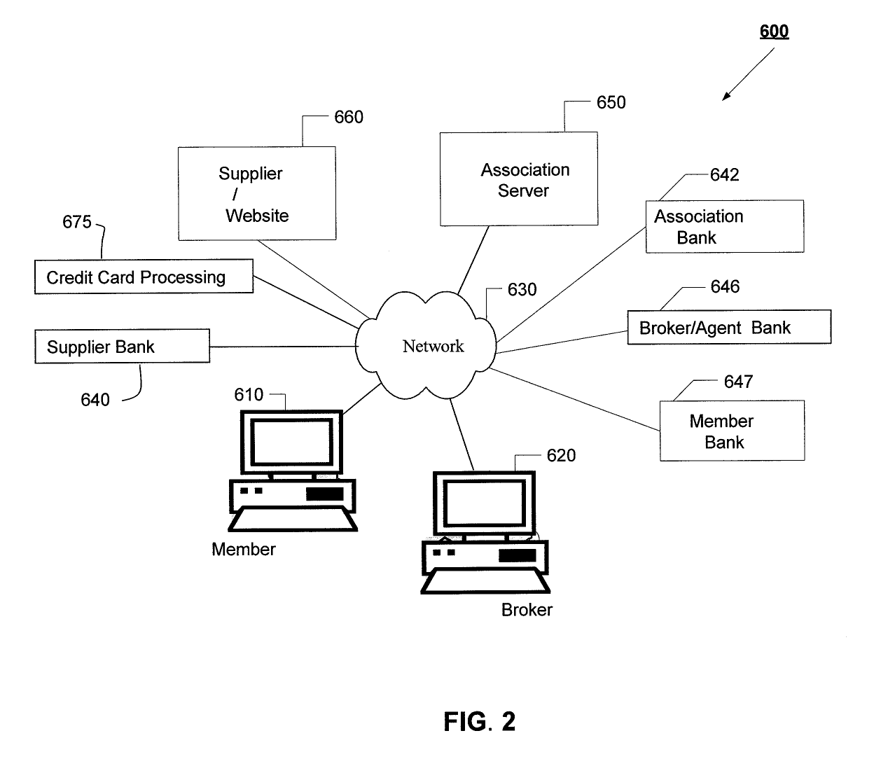

FIG. 2 shows a block diagram of a computer system 600 for providing the distribution system 10, in accordance with various embodiments of the present invention. As may be understood from this figure, the system 600 may include one or more computing devices or systems 610, 620, which may be used, for example by a member 14 or an advisor, such as a broker/agent 16, to communicate with an insurance carrier computer system 660 which may include an insurance sales or information server or website via a network 630 (for example, a Local Area Network (LAN), wide area network (WAN), the Internet, or the like). In a well known manner, a remote computer system, such as the broker/agent computer system 620, may access the carrier computer system 660 for the purpose of receiving insurance quote information or recommendations for one or more insurance products or policies, purchasing insurance online by way of an Internet-based insurance rating and underwriting system, renewing or modifying an existing insurance product, or administering insurance policies. Either or both computing device 610, 620 may include, for example, a personal computer (PC), laptop, personal digital assistant (PDA), cellular telephone, or similar electronic device. According to one exemplary embodiment, the insurance sales/information website may be operated by an insurance carrier computer system 660 by way of the same or a different network 630. In other embodiments, the insurance sales/information website 660 may be operated by a third party for the purpose of allowing a customer or advisor to interface with systems of an insurance provider. The server or website 660 is also referred to as a supplier server or website.

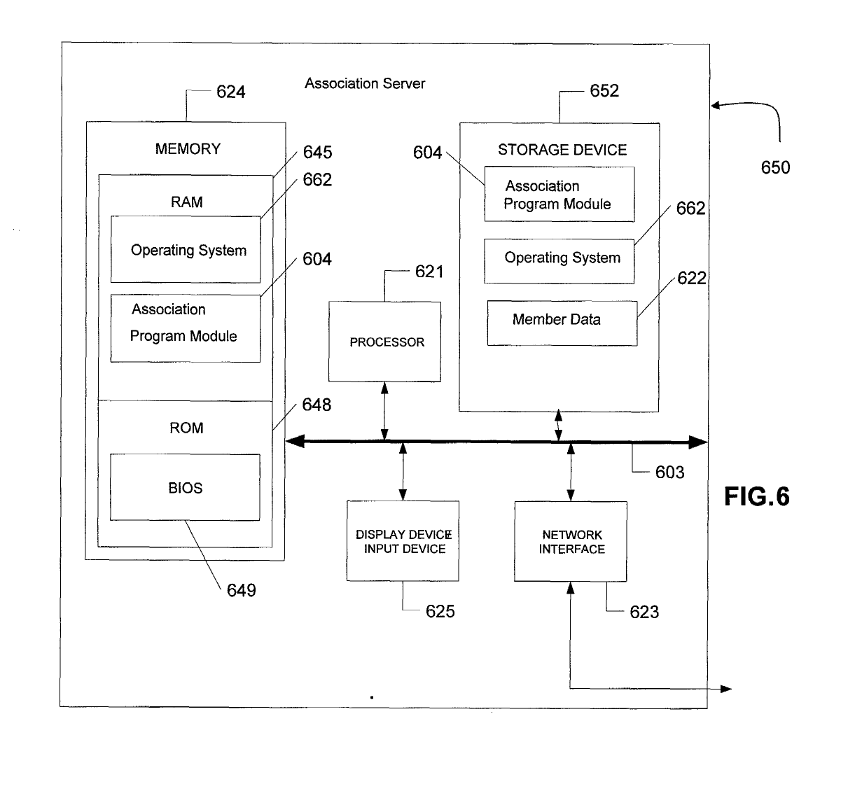

The association server 650 of one exemplary embodiment of the invention may be configured to execute an association program module 604, shown in FIG. 6, in order to provide communications, data storage, calculations, payment instructions, and the like, as described above in connection with the distribution program 10 of the invention. The system 600 may further include a supplier bank server or website 640, maintained by a bank at which the insurance provider or other affinity program supplier has an account and connected to the network 630. The system 600 may further include an association bank server or website 642 maintained by a bank at which the association has an account and connected to the network 630. The system 600 may further include a brokerage bank server or website 646 maintained by a bank at which the intermediary has an account and connected to the network 630. The system 600 may further include a member bank server or website 647 maintained by a bank at which the member has an account and connected to the network 630. The bank computer systems 640, 642, 646, and 647, each is capable of receiving instructions from account owner computer systems 660, 650, 620 and 610, respectively, to transfer funds from appropriate accounts to other banks on the network, and is capable of receiving funds from other bank computer systems into designated accounts. The network 630 may also be linked to a conventional credit card processor 675, such as Discover, VISA, MasterCard, or American Express.

The system 600 also may include one or more external data storage devices (not shown) providing computer memory and connected to the network 630 and accessible to the computer systems also connected to the network.

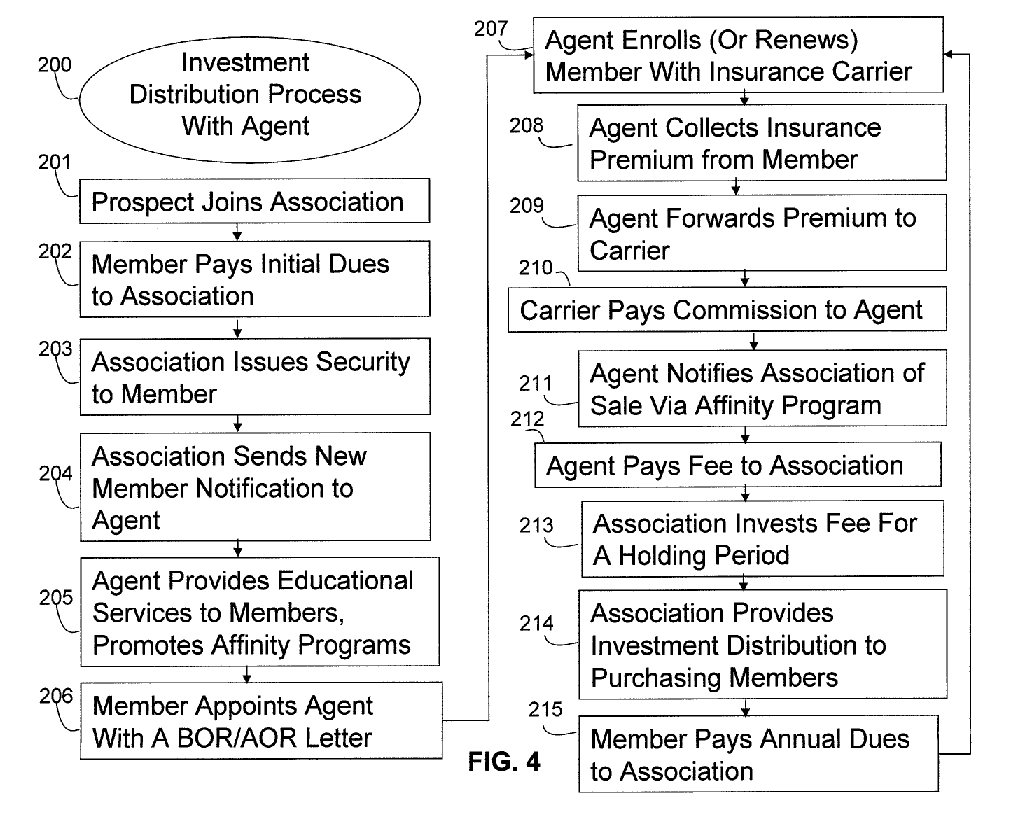

FIG. 4 is a flow chart illustrating the steps of a process 200 of providing distributions to association members based on affinity programming purchases according to the invention, carried out by one or more computer systems embodying the invention. At Step 201, prospective member joins an employer benefits association 12 established as described above. In the exemplary embodiment shown in FIG. 4, the benefits of the association are tailored to employers who provide group health insurance to their employees. Such prospective members may be employers from any part of the economy, such as automobile dealers, accounting or consulting firms, professional firms, manufacturers, restaurants, retail stores, service providers, or others. Thus, the prospective member for this exemplary association is a business, whether a corporation, limited liability company, partnership, or individual proprietorship. The prospect becomes a member 14 by signing a membership enrollment agreement and, if the membership interests are to be unregistered, an operating agreement limiting transferability of the interests. Also, at Step 202, the member pays annual dues 30 to the association, for example, from the member bank 24 by electronic funds transfer to the association bank 22, or by on-line credit card payment over the network. The member computer system 610 may be programmed to provide appropriate instructions for payment to the member bank 24. The dues may be based on the number of full time equivalent employees (FTE) employed by the member 14, such as one dollar ($1.00) per FTE, or on another basis established by agreement.

At Step 203, the association 12 issues to the member 14 membership interests entitled to distributions 44 when paid by the association. The association transmits notification 31 of updated membership with the new member information to the intermediary broker/agent 16 at Step 204. Such communication may be sent between the respective computer systems over a computer network by email or by known data transfer protocols. At Step 205, the broker/agent works with the association to promote association sponsored affinity purchase programs, such as goods or services, for example group health insurance, and also provides educational services to association members as described above. The educational services may be made available to members online over the Internet, or transmitted by email, or live seminars and the like may be provided. In the case of affinity program purchases, the member may choose between sponsored providers and between the goods or services to be purchased from a sponsored provider.

When a member desires to participate in the group health affinity program, the member provides a BOR/AOR letter 33 at Step 206 authorizing the broker/agent to negotiate on the member's behalf with an insurance carrier 18 to enroll the member in a group health insurance or other insurance plan. The letter 33 may be sent by fax or email. The broker/agent uses this authorization to enroll the member in the insurance plan at Step 207 pursuant to an insurance policy 38. The broker/agent 16 collects the insurance premium 36a from the member 14 at Step 208, which may be paid by electronic funds transfer from member's account in the member bank 24 to the broker/agent's account in the intermediary bank 26, pursuant to instructions from the member computer system to the member bank computer system, or by on-line credit card payment over the network to the broker/agent's account. The broker/agent forwards the premium 36b to the carrier 18 at Step 209 and at Step 210 is paid subsequently a commission or consulting fee based on the premium payment. The intermediary computer system 620 may be programmed to receive notification of receipt of the premium 36a into the broker/agent's account in the bank 26 from the bank computer system 646, calculate the commission or consulting fee, and instruct the bank system 646 to transfer the premium 36b to the carrier's account in the carrier bank 28.

At Step 211, the broker/agent computer system 646 also is programmed to send a notification of the member's enrollment with the carrier to the computer system 650 of the association 12, and at Step 212, to instruct the intermediary bank 26 to transfer the royalty or license fee 34 from the broker/agent's account to the association's account in the association bank 22. The information provided in the notice of Step 211 includes the amount of fees 34 attributable to the individual member who made the purchase, the commission rate or consulting fee due to the broker/agent on the sale of the insurance policy, and the starting and ending dates of the term of the member's insurance policy.

The license agreement between the association and the intermediary may provide for any portion up to 100% of the revenue received by the intermediary from the supplier to be paid to the association, although this may be expressed in terms of the purchase amount paid to the supplier. The broker/agent computer system 646 and the association computer system 650 may store a look-up table in memory to be accessed by the computer systems for determining the percentage fee due to the association for each affinity purchase of insurance by an association member, consistent with the negotiated license fee. The license fee rate due to the association may vary with the size of a commission received if the fee is based on commissions. A sample table is shown in Table 1.

TABLE 1

| Commission | Rate |
|---|---|
| 1%-2% | 0.25% |
| 2%-3% | 0.50% |
| 3%-4% | 1.0% |
| 4%-5% | 1.5% |
| 5%-6% | 2.0% |
| 6% & higher | 2.25% |

In the alternative, the computers may utilize an algorithm to derive the fee rate from the commission, based on the negotiated amount of the license fee 34. The amount and manner for determining the fee 34 may be varied according to the agreement 20 between the association 12 and the broker/agent 16. The computers then may apply the calculated Fee Rate to the amount of the premium 36 paid for the affinity insurance policy. The broker/agent computer system 646 then instructs the intermediary bank computer system 640 to transfer the resulting fee 34 from the broker/agent account in the bank 26 to the association account in the association bank 22. The association computer system 650 may use the calculation results to verify the correct fee payment.

In the alternative, the data used for the fee rate calculation may be stored at a location on the network remote from either computer system, or stored on one of the computer systems and accessed by the other computer system via the network.

The association may commingle the fees received in connection with affinity purchases of various members and invest such fees for a holding period at Step 213. The holding period in the case of insurance purchases may be at least the initial policy term. The association computer system may be programmed to track amounts of fees 34 attributable to individual members of the association, the starting and ending dates of the term of each member's policy associated with fees that have been paid, and the date of receipt of the fees into the association's account. The association computer system 650 may further be programmed to associate in memory the end of the member's policy term with the end of the holding period as applied to that member.

The association computer system 650 is programmed to calculate and output investment distributions 44 at Step 214, and may also be programmed to pay investment distributions 44 to association members.. The output may be provided to display 625 or via the network to a device such as one of printers 618 or 628 or a workstation 68 or 626. Distributions may be payable to members on a set date or interval, or may be payable to individual members as holding periods (described above) expire. The distribution due to an individual member may be the fees 34, received from the intermediary broker/agent 16, attributable to affinity purchases by that member for which the holding period has expired, less an amount needed for the operating expense requirements of the association's business, as recorded in the memory of the association computer system 650. Or, as another example, the association computer system may be programmed to pay a set percentage (such as 2%) of the member's total premiums paid for affinity programming purchases for which the holding period has expired, as recorded in the memory of the association computer system. The percentage of premiums set in the latter example may be altered as desired by the association.

In another alternative embodiment, the association computer system 650 may receive from the association bank computer system 642 the amount of interest earned on the commingled fees received from intermediaries. The distribution due to an individual member may be the fees 34, received from the intermediary broker/agent 16, attributable to affinity purchases by that member for which the holding period has expired, plus a percentage (for example, 15%) of the interest earned by the association on all such fees 34 earned by all the members regardless of attribution. Optionally, the distribution amount from fees 34 may be reduced by an amount needed for the operating expense requirements of the association's business.

The members thus receive an investment return on the dues submitted. In the exemplary embodiment of FIG. 2, distributions are paid annually to members. In Step 215, the member pays its annual dues to the association. The process of the invention loops back to Step 207, where the broker/agent 16 renews the insurance policy 38, then proceeds to Steps 208 through 214 to the payment of the next annual distribution 44.

The agreements 32 between the member and the association may include a membership enrollment agreement of the type attached hereto as Appendix A, and an operating agreement of the type attached hereto as Appendix B. The membership enrollment agreement may include within its terms agreements and acknowledgements by an applying member relating to the nature of the association, the nature of the investment in the association, and limitations on transfer of membership interests. The operating agreement may include within its terms fiscal and organizational provisions, the business of the association, rights and obligations of members, requirements for dues and distributions, management, and other provisions appropriate for the association. The agreement 20 between the association and the intermediary may be a license agreement of the type attached hereto as Appendix C that includes within its terms granting to the intermediary the right to use defined trademarks and other proprietary rights of the association in connection with affinity programming sponsored by the association under quality standards; providing for payment of license fees as described above; providing for sponsorship activities to be undertaken by the association; providing for operation of affinity programs and educational programs by the intermediary; providing generally for the parties to cooperate for the benefit of the goals of the association for its members; and providing other provisions appropriate for the relationship.

Turning to additional specific examples of insurance affinity programs, the present invention may be applied to insurance lines making up a members “Package Policy”. In the matter of Royalty Fees/Marketing Fees; the association and the insurance agent will agree upon a structured percentage fee (to be paid by the agent to the association) based on the average of all package policy lines revenue generated.

### EXAMPLE 1

Association member ABC Company pays $650,000 for their Property & Liability Package Policy. The package includes coverage lines that insure the following:
Property & Inland Marine
Business Income
General Liability
Auto Policy (Comp, Collision & Liability)
Workers Compensation
Commercial Umbrella
Specific coverage lines are written through different carriers; however the insurance agency is paid an average of 12% commissions on the final premium.
In this example, the agency would pay a royalty/marketing fee of 3% (or $19,500) to association per their license agreement. The $19,500 would be held by the association for the term of the contract, and then released back to the member via the association's business plan for distributions.

### EXAMPLE 2

Association member ABC Company purchases Fiduciary Bonds from the association's recommended vendor. The bonding premium is $500,000 with a 20% commission rate. The vendor would pay 5% or $25,000 to the association as a marketing fee (per license agreement). The association would collect the fee and hold it for the term of the contract with the vendor. The association would then release the appropriate portion of the fee to the client as a distribution, in some cases totaling 100% of the collected fees.

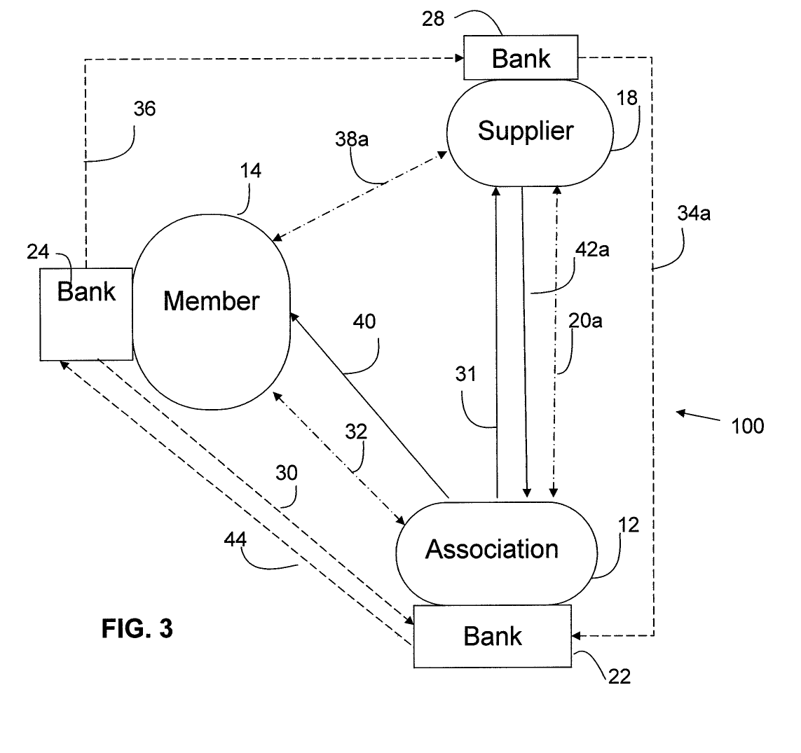

Referring now to FIG. 3, another embodiment of the relationships of the entities involved in a system 100 according to the present invention are shown diagrammatically. Elements in common with the embodiment of FIG. 1 share the same reference numerals in FIG. 3. Differences between the embodiments will be pointed out, and where aspects of the embodiments are the same, the description above in connection with FIG. 1 also applies to the embodiment of FIG. 3.

In the embodiment of FIG. 3, the association 12 deals directly with the supplier or vendor 18, without an intermediary. As a result, the association 12 enters into affinity license or royalty agreements 20 a with one or more suppliers 18. Again, the license agreements 20 a may be exclusive or nonexclusive. The license agreements provide disposable, net income to the association 12 in the form of license or royalty fees 34a, in exchange for the association sponsoring the vendor's goods or services. In the example shown in FIG. 3, the sponsored program supplier may be, for example, a professional service provider in a field such as public relations, advertising, accounting, legal, or information technology. Or, the sponsored program supplier may be a wholesale or retail merchant of physical goods. The association also may furnish and update (as new members enroll in the association) a list 31 of association members to the vendor 18. The association may send a separate notice of each new member, for example by email.

Members 14 deal directly with suppliers 18 for the sale of sponsored goods or services in the embodiment of FIG. 3, and make payments 36 to the supplier 18. The supplier 18 sends notification 42a to the association 12 whenever a member engages the supplier by way of an agreement 38a, or purchases goods or services. Upon receiving payment from a member, the supplier provides an accounting to the association and pays the association a license fee 34a, representing a portion of the payments 36 collected by the supplier from the association sponsored programs, as provided in the license agreement 20a. Again, the association may invest the license fees and receive interest or other investment returns as income. The association may itself conduct educational programming 40 for members or contract with others to do so.

As was the case for programs shown in FIG. 1, a holding period is established for distributions based on FIG. 3 programs. As established by the agreement 32, the holding period may be, for example, the length of the term of a contract between the member and the supplier. When sponsored services are provided for an hourly charge, or in the case of the sale of goods, a set time period may be selected by the parties in the agreement 32 for the holding period. The holding period may also be set to optimize income to be applied to association expenses. With respect to calculation of distributions, and the transfer of funds, the discussion above in connection with FIG. 1 generally applies.

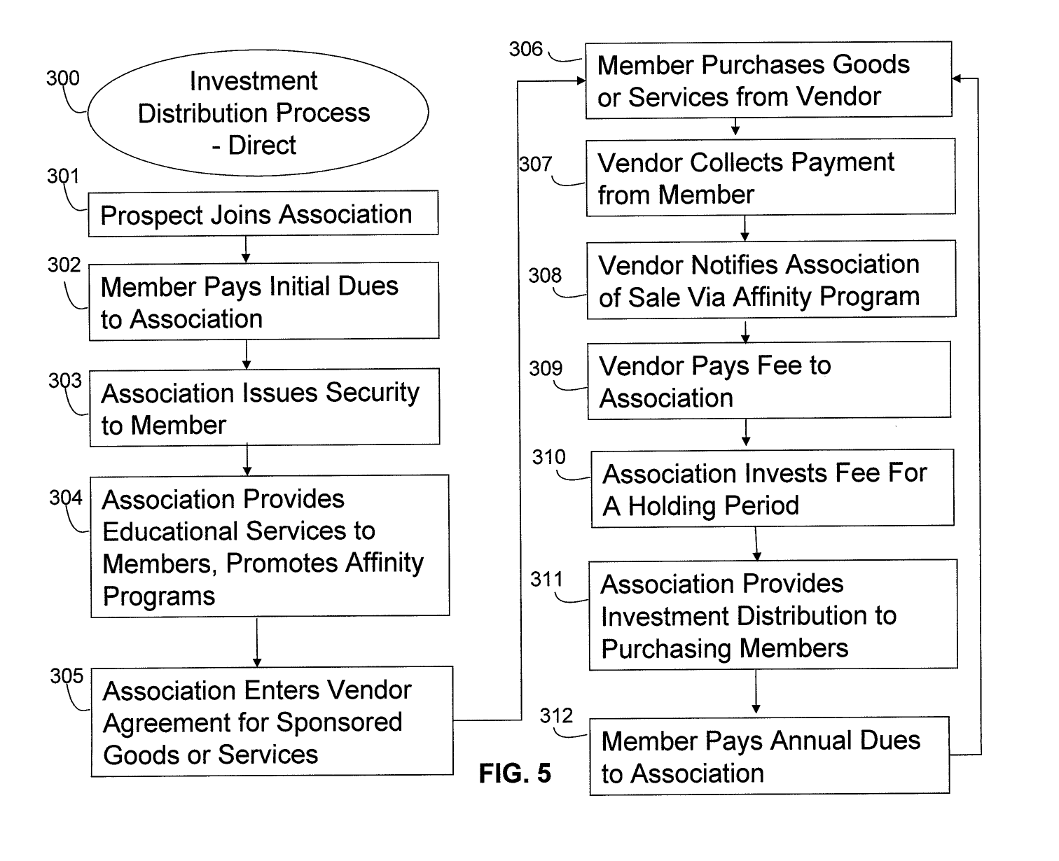

FIG. 5 is a flow chart illustrating the steps of a process 300 of providing distributions to association members based on affinity programming purchases according to the embodiment of invention shown in FIG. 3, carried out by one or more computer systems embodying the invention. At Step 301, prospective member joins an employer benefits association 12 established as described above. In the exemplary embodiment shown in FIG. 5, the benefits of the association are tailored to employers who provide sponsored goods or services to their employees. The prospect becomes a member 14 by signing a membership enrollment agreement 32 and, if the membership interests are to be unregistered, an operating agreement limiting transferability of the interests. Also, at Step 302, the member pays annual dues 30 to the association, for example, from the member bank 24 by electronic funds transfer to the association bank 22, or by on-line credit card payment over the network.

At Step 303, the association 12 issues to the member 14 membership interests, such as securities, entitled to distributions 44 when paid by the association. At Step 304, the association provides educational services to association members and either the association or the suppliers or both work to promote association sponsored affinity purchase programs. At step 305, the association enters into a sponsorship license agreement 20 a with the supplier 18 to establish one or more affinity programs.

When a member desires to participate in an affinity program, the member contacts a sponsored supplier 18 to engage the supplier and purchase goods or services, at step 306. The supplier 18 collects payment 36 from the member 14 at Step 307; the payment may be paid by electronic funds transfer from member's account in the member bank 24 to the supplier's account in the supplier bank 28, pursuant to instructions from the member computer system to the member bank computer system, or by on-line credit card payment over the network to the supplier's account. At step 308, the supplier computer system 660 may be programmed to send, and the association computer system 650 may be programmed to receive, notification from the bank computer system 640 of receipt of the payment 36 into the supplier's account in the bank 28.

At Step 309, the supplier's computer system 660 also is programmed to instruct the supplier bank 28 via the supplier bank computer system 640 to transfer the royalty or license fee 34 a from the supplier's account to the association's account in the association bank 22. The information provided in the notice of Step 308 may include the amount of fees 34 a attributable to the individual member who made the purchase, and any relevant dates pertaining to the relationship between the member and the supplier that may be needed for distribution purposes.

The supplier computer system 660 and the association computer system 650 may store a look-up table in memory to be accessed by the computer systems for determining the percentage fee due to the association for each affinity purchase by an association member, in the manner described above in connection with Table 1. The values of the look-up table will reflect the parties' agreement for the fee, rather than reflecting an intermediary's commission. The computers then may apply the appropriate fee percentage to the amount of the payment 36 paid for the affinity program purchases.

The association may commingle the fees received in connection with affinity purchases of various members and invest such fees for a holding period at Step 310, as discussed above. The association computer system may be programmed to track amounts of fees 34 a attributable to individual members of the association, the starting and ending dates of the term of each member's supplier relationships associated with fees that have been paid, and the date of receipt of the fees into the association's account. The association computer system 650 may further be programmed to track and store in memory dates related to the holding period as applied to that member.

The association computer system 650 is programmed to calculate calculate and output investment distributions 44 at Step 311, and may also be programmed to pay investment distributions 44 to association members. The output may be provided to display 625 or via the network to a device such as one of printers 618 or 628 or a workstation 68 or 626. Distributions may be payable to members on a set date or interval, or may be payable to individual members as holding periods (described above) expire. The distribution due to an individual member may be the fees 34a, received from suppliers 18, attributable to affinity purchases by that member for which the holding period has expired, less an amount needed for the operating expense requirements of the association's business, as recorded in the memory of the association computer system 650. Or, the association computer system may be programmed to pay a set percentage (such as 2%) of the member's total payments paid for affinity programming purchases for which the holding period has expired, as recorded in the memory of the association computer system. The percentage of premiums set in the latter example may be altered as desired by the association. The addition of earned interest to the distribution may be implemented as described above in the embodiment of the process as described in connection with FIG. 4.

The members thus receive an investment return on the dues submitted. In Step 312, the member pays its annual dues to the association. The process of the invention loops back to Step 306, for additional affinity program purchases, then proceeds to Steps 307 through 312 to the payment of the next annual distribution 44.

The following examples illustrate embodiments of the present invention:

### EXAMPLE 3

### Intermediary Example

Association Member purchases Product(s) and/or Service(s) from a licensed vendor of the Association. Purchaser now becomes Member/Client.
The licensed vendor, a Sales Representative of the Supplier/Manufacturer of the Product(s) and/or Service(s) is paid a fee or “commission” for placing those Product(s) and/or Service(s) with the now Member/Client.
That sales representative then pays a marketing fee to the Association from a portion of his or her revenue/commission. Please see the example below:
John Doe sells products for ABC Company. John sells a product line to an Association Member that generates a commission of $100,000 per year. Since John is a Licensed Vendor for the Association, he is required to pay a 30% marketing fee to the association. This fee will result in a distribution for the Member/Client pursuant to the Terms of the Association's Class A Membership.

| | |
|---|---|
| Total Commission/Gross Revenue- | $100,000 |
| Marketing Fee- | $30,000 |

### EXAMPLE 4

### Vendor Direct Example

Association Member purchases Product(s) and/or Service(s) from a licensed vendor of the association. Purchaser now becomes Member/Client.
The Licensed Vendor the Member/Client contracts with is DEF Cell Phone Company. The contract DEF Co. signed with the association requires that 10% of the monthly service fees be paid to the Association as a Marketing Fee.

The Member/Client has 1000 employees that utilize the corporate cell phone plan. The Member/Client pays $100 per member per month for said service. The Member/Client pays $100,000 per month or $1,200,000 per year to DEF Cell Phone Company for the contracted service(s) rendered.

| | |
|---|---|
| Total Contracted Price- | $1,200,000 |
| Marketing Fee- | $120,000 |

Pursuant to one embodiment of the Association's business model, $120,000 would be distributed back to the Member/Client.

Turning to more specific examples of non-insurance affinity programs, the present invention may be applied to members' use of sponsored firms in areas of:

### EXAMPLE 5

### Public Relations/Advertising

The member payments can be based on per project price proposal or on hourly fees. In the case of a Per Project price, the member pays a lump sum for a project or for a period of time, such as $1,000,000 of annual advertising budget to the sponsored vendor. That vendor then pays the association an agreed upon percentage of the total project invoice (determined by signed license agreement amounts) as a royalty/membership marketing fee. The association holds the royalty for the term of the member's contract with the vendor, and then releases a portion of the fee back to the client in the form of the distribution. In the case of an Hourly Fee, the amount of the fee will vary by month depending upon total number of billable hours. The royalty fee paid by the vendor to the association will also be made monthly after the vendor's invoice has been paid by the member. Otherwise the steps would be similar to a per project approach.

### EXAMPLE 6

### Certified Public Accounting

This affinity purchasing program would be similar to PR/Advertising above when charges are on an hourly basis.

Legal Profession (Regardless of Specialty): This affinity purchasing program would be similar to PR/Advertising above when charges are on an hourly basis. Retainers will not be considered when calculating the royalty owed to the association unless or until applied to work done. Royalties/Marketing Fees will only be calculated on a billed basis and would be transparent through invoices and accounting methods supplied to the association from the vendor.

Web-Site Design/Copy Editing: This affinity purchasing program could be on a per project or hourly fee basis, and would be similar to PR/Advertising above.

FIG. 6 provides a schematic diagram of the association server 650 according to one exemplary embodiment of the invention. As shown, the association server 650 may include a processor 621 that communicates with other elements within the association server 650 via a system interface or bus 603. The processor 621 could be, for example, a central processing unit, microprocessor, microcontroller, programmable gate array, or some other device that processes data. Also included in the association server 650 of this exemplary embodiment is a display device/input device 625 for receiving and displaying data. The unit 625 may include, for example, an input device such as a keyboard, mouse or pointing device, and a display device such as a monitor, cathode ray tube (CRT), liquid crystal display (LCD), or other such device. The association server 650 may further include a memory 624, which includes both random access memory (RAM) 645 and read only memory (ROM) 648. The computer's ROM 648 may be used to store a basic input/output system 649 (BIOS), containing the basic routines that help to transfer information between elements within the association server 650.

In addition, the association server 650 may include at least one storage device 652, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 652 is connected to the system bus 603 by an appropriate interface. The storage devices 652 and their associated computer-readable media provide nonvolatile storage. The computer-readable media described above could be replaced by any other type of computer-readable media known in the art. Such media include, for example, magnetic cassettes, flash memory cards, digital video disks, and Bernoulli cartridges.

A number of program modules comprising, for example, one or more computer-readable program code portions executable by the processor 621, may be stored by the various storage devices 652 and within RAM 645. Such program modules may include an operating system 662, and an association program module 604. The association program module 604 controls certain aspects of the operation of the association server 650, as is described in more detail herein, with the assistance of the processor 621 and the operating system 662. The association program module 604 contains software needed to present and administer the system 10 as described herein.

The storage device 652 may also include a member database 622 of member data for members of the association, such as the stored information described relating to affinity purchases, policy term dates, and commission rates. In the alternative, the member data may be stored in another device elsewhere on the network. Also located within the association server 650 is a network interface 623, for interfacing and communicating with other elements of a computer network, such as the elements shown in FIG. 2. It will be appreciated by one of ordinary skill in the art that one or more of the association server 650 components may be located geographically remotely from other association server 650 components. Furthermore, one or more of the components may be combined, and additional components performing functions described herein may be included in the association server 650.

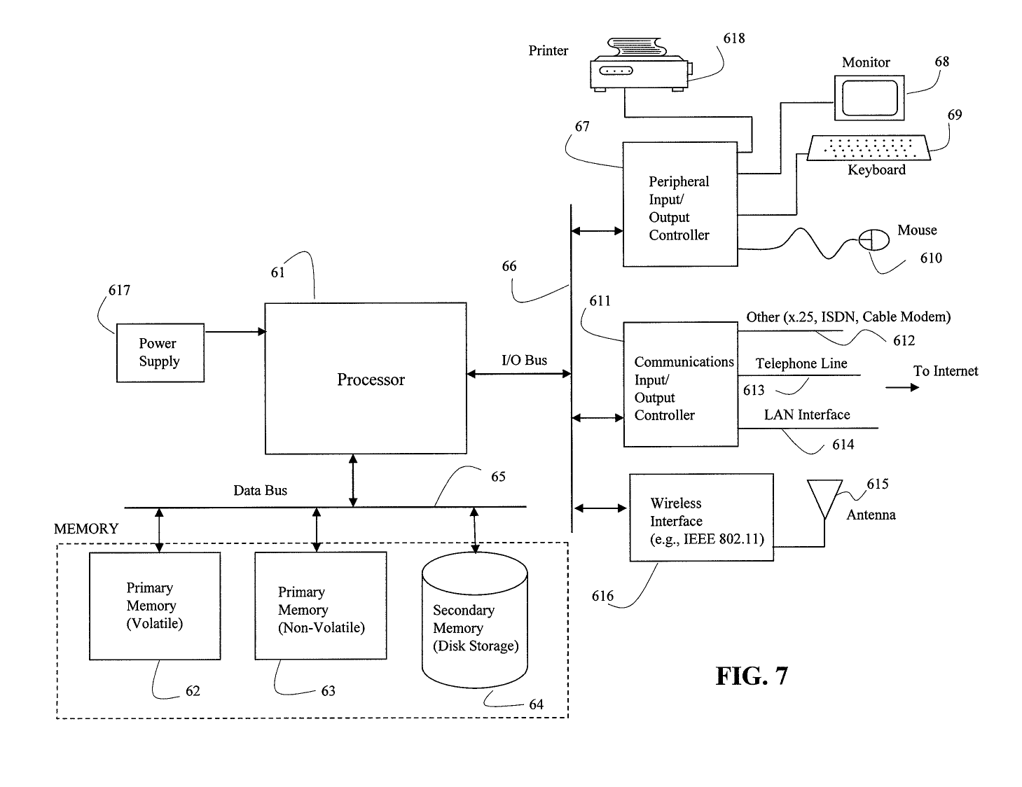

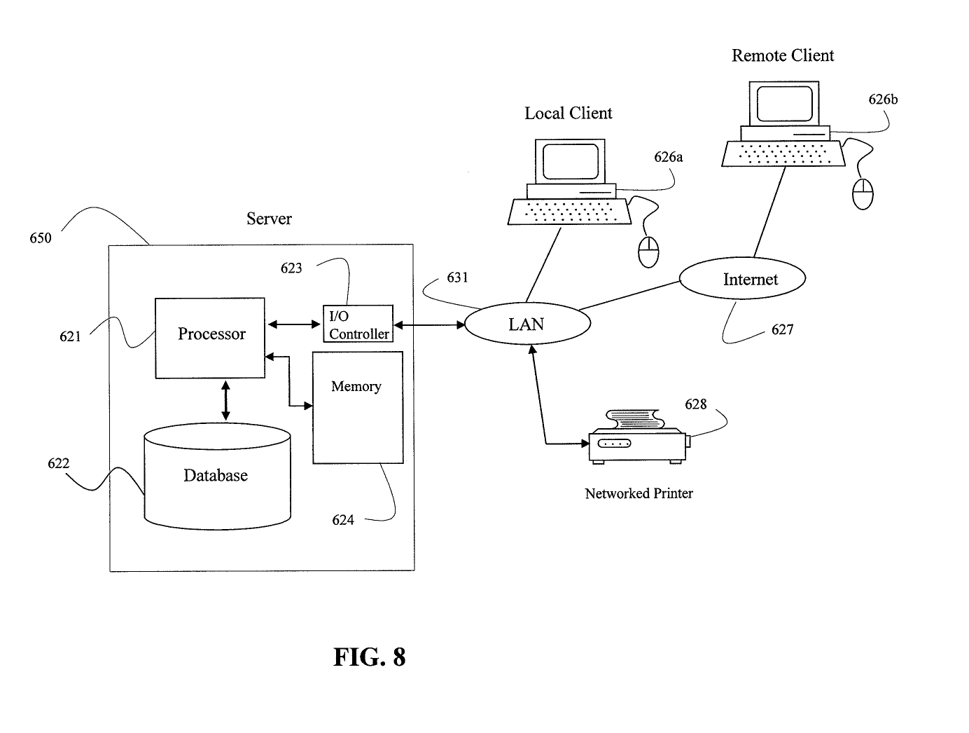

Some method steps of the present invention can be completed by updating computer memories or transferring information from one computer memory to another. Other examples of computer components that can be used to implement the present invention (for example, the modules of FIG. 6) are described in connection with FIGS. 7 and 8. Turning to FIG. 7, one embodiment of a computer is illustrated that can be used to practice aspects of the present invention, such as the various computer systems described herein. The systems and methods of the present invention can be implemented using computer hardware and computer readable memory containing information and instructions to carry out the disclosed method. In FIG. 7, a processor 61, such as a microprocessor, is used to execute software instructions for carrying out the defined steps. The processor receives power from a power supply 617 that also provides power to the other components as necessary. The processor 61 communicates using a data bus 65 that is typically 16 or 32 bits wide (e.g., in parallel). The data bus 65 is used to convey data and program instructions, typically, between the processor and memory. In the present embodiment, memory can be considered volatile primary memory 62, that is RAM or other forms which retain the contents only during operation, or it may be non-volatile memory 63, such as ROM, EPROM, EEPROM, FLASH, or other types of memory that retain the memory contents at all times. The memory could also be secondary memory 64, such as disk storage, that stores large amount of data. In some embodiments, the disk storage may communicate with the processor using an I/O bus 66 or a dedicated bus (not shown). The secondary memory may be a floppy disk, hard disk, compact disk, DVD, or any other type of mass storage type known to those skilled in the computer arts. One of ordinary skill will recognize that as data is transferred between two or more computing devices (in accordance with the above-described processing steps), the data is read from and written to one or more of these memory areas and the memory area is physically changed as a result of the process.

The processor 61 also communicates with various peripherals or external devices using an I/O bus 66. In the present embodiment, a peripheral I/O controller 67 is used to provide standard interfaces, such as RS-232, RS 422, DIN, USB, or other interfaces as appropriate to interface various input/output devices. Typical input/output devices include local printers 618, a monitor 68, a keyboard 69, and a mouse 610 or other typical pointing devices (e.g., rollerball, trackpad, joystick, etc.).

The processor 61 typically also communicates using a communications V/O controller 611 with external communication networks, and may use a variety of interfaces such as data communication oriented protocols 612 such as X.25, ISDN, DSL, cable modems, etc. The communications controller 611 may also incorporate a modem (not shown) for interfacing and communicating with a standard telephone line 613. Additionally, the communications 1/0 controller may incorporate an Ethernet interface 614 for communicating over a LAN. Any of these interfaces may be used to access the Internet, intranets, LANs, or other data communication facilities.

Also, the processor 61 may communicate with a wireless interface 616 that is operatively connected to an antenna 615 for communicating wirelessly with other devices, using for example, one of the IEEE 802.11 protocols, 802.15.4 protocol, or a standard 3G wireless telecommunications protocols, such as CDMA2000 1x EV-DO, GPRS, W-CDMA, or other protocol.

A further alternative embodiment of a processing system that may be used is shown in FIG. 8. In this embodiment, a distributed communication and processing architecture is shown involving, for example, the association server 650 communicating with either a local client computer 626a or a remote client computer 626b. The server 650 typically comprises a processor 621 that communicates with a database 622, which can be viewed as a form of secondary memory, as well as primary memory 624. The processor also communicates with external devices using an I/O controller 623 that typically interfaces with a local area network (LAN) 631. The LAN may provide local connectivity to a networked printer 628 and the local client computer 626a. These may be located in the same facility as the server, though not necessarily in the same room. Communication with remote devices typically is accomplished by routing data from the LAN 631 over a communications facility to the Internet 627. A remote client computer 626b may execute a web browser, so that the remote client 626b may interact with the server as required by transmitted data through the Internet 627, over the LAN 631, and to the server 650. The network 630 in FIG. 2 may be the Internet. References made herein to a network are meant to include one or more networks configured to carry out the function or feature being described.

Those skilled in the art of data networking will realize that many other alternatives and architectures are possible and can be used to practice the principles of the present invention. The embodiments illustrated in FIG. 7 and 8 can be modified in different ways and be within the scope of the present invention as claimed. It should be understood that many individual steps of a process according the invention may or may not be carried out utilizing the computer systems described, and that the degree of computer implementation may vary from association to association.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An association computer system programmed with executable instructions configured to:
receive via a computer network notification of transfer to an account of the association in an association bank a fee based on payment by a member of the association to be applied to an affinity program purchase from a supplier;
provide an instruction to an association bank to hold the fee for a holding period;
calculate a distribution amount based at least in part on the fee; and
output an indication of the distribution amount to be distributed after the holding period.

2. The system of claim 1, wherein the fee is based on revenue received from the supplier by an intermediary associated with the payment, and the notification is received from an intermediary bank computer system.

3. The system of claim 2, wherein the association computer system is further programmed with executable instructions configured to receive via the computer network, notification from an intermediary computer system of payment by a member of the association to be applied to an affinity program purchase from a supplier.

4. The system of claim 1, wherein the system is further configured to subtract predetermined deductions from the fee when calculating the distribution.

5. The system of claim 1, wherein the system is further configured to calculate the distribution based at least in part on the payment.

6. The system of claim 5, wherein the system is further configured to calculate the distribution by adding an amount proportional to interest earned by the association on the fee.

7. The system of claim 6, wherein the affinity program purchase is insurance coverage.

8. The system of claim 7, wherein the holding period is equal to or greater than an initial insurance policy term.

9. The system of claim 1, wherein the system is further configured to calculate the distribution by adding an amount proportional to interest earned by the association on the fees attributable to purchases of a plurality of association members.

10. The system of claim 1, wherein the association computer system is configured to provide to an association bank computer the instructions to the association bank to hold the fee and an instruction to distribute the calculated amount to the member.

11. A member computer system programmed with executable instructions configured to:
instruct a member bank to transfer a payment to an intermediary to be applied to a purchase pursuant to an affinity program of an association to which the member belongs; and
receive notification from an association computer system of a distribution transferred from an association bank to the member bank following a holding period, the distribution being based on a fee transferred to the association bank by the intermediary, the fee being funded by revenue of an intermediary associated with the payment.

12. The system of claim 11, wherein the distribution includes an amount proportional to interest earned by the association on the intermediary fees attributable to affinity program purchases of a plurality of association members.

13. A method for processing payments based on an affinity program, comprising:
receiving at an association computer system, via a computer network, notification of a payment by a member of an association to be applied to an affinity program purchase from a supplier;
receiving in an account of the association a fee associated with the payment;
holding the fee for a holding period;
calculating a distribution amount based at least in part on the fee; and
distributing, after the holding period, the calculated amount as a distribution to the member.

14. The method of claim 13, wherein the distribution is further based in part on interest earned by the association on the fees attributable to affinity program purchases of a plurality of association members.

15. The method of claim 13, wherein calculating the distribution is based at least in part on the payment.

16. The method of claim 13, wherein calculating the distribution includes subtracting from the fee predetermined deductions.

17. The method of claim 13, wherein the fee is received from an intermediary, and calculating the distribution using the association computer system further comprises adding an amount proportional to interest earned by the association on intermediary fees attributable to a plurality of association members.

18. The method of claim 13, wherein calculation of the distribution amount is done using the association computer system, and wherein one or both of receiving the fee or distributing the distribution is via electronic funds transfer.

19. A method for providing payments based on insurance premiums, comprising:
establishing a non-profit association including members;
collecting a dues payment from said members;
establishing an affinity program for purchasing insurance from sponsored insurance providers through one or more selected intermediaries;
providing the intermediaries with promotional access to the members via a computer network;
receiving at an association computer system, via a computer network, notification from one of the intermediaries of a premium payment by a member of the association to be applied to purchase of an insurance policy from one of the insurance providers;
receiving in an account of the association from said one of the intermediaries a fee based on a commission associated with the premium payment, the commission being received by the intermediary from said one of the insurance providers;
holding the fee for a holding period of at least the current term of the insurance policy;
calculating a distribution amount based at least in part on the intermediary fee, plus an amount proportional to interest earned by the association on intermediary fees attributable to a plurality of members of the association; and
distributing, after the holding period, the calculated amount as a distribution to the member.

20. The method of claim 19, wherein calculation of the distribution amount is done using the association computer system, and wherein one or both of receiving the fee or distributing the distribution is via electronic funds transfer.
